(19) United States
(12) Patent Application Publication
(10) Pub. No.: US 2011/0084000 A1
(43) Pub. Date: Apr. 14, 2011

(54) SYSTEMS AND METHODS FOR PROCESSING NOZZLE REACTOR PITCH

(75) Inventors: Willem P.C. Duyvesteyn, Reno, NV (US); Jose Armando Salazar, Reno, NV (US); Christopher Daniel Ard, Sparks, NV (US)

(73) Assignee: MARATHON OIL CANADA CORPORATION, Calgary (CA)

(21) Appl. No.: 12/579,193

(22) Filed: Oct. 14, 2009

(51) Int. Cl. C10G 9/38; B01J 8/24; C10G 9/00

(52) U.S. Cl. 208/130; 422/145

(57) ABSTRACT

Methods and systems for cracking hydrocarbon material in a nozzle reactor and processing any un-cracked hydrocarbon material passing through the nozzle reactor. The nozzle reactor used may have a configuration whereby cracking material is injected into the nozzle reactor at a high velocity, including supersonic speed. The hydrocarbon material is injected into the nozzle reactor and intersects with the cracking material to crack hydrocarbon material. Any hydrocarbon material that pass through the nozzle reactor un-cracked can be re-injected into the nozzle reactor. An increase in the concentration and amount of un-cracked hydrocarbons injected into the nozzle reactor may increase the overall conversion of hydrocarbons into lighter hydrocarbons.

### BACKGROUND

Some nozzle reactors operate to cause interaction between materials and achieve alteration of the physical or chemical composition of one or more of the materials. Such interaction and alteration typically occurs by injecting the materials into a reactor chamber in the nozzle reactor. The manner in which the materials are injected into the reactor chamber and the configuration of the various components of the nozzle reactor may both contribute to how the materials interact and what types of alterations are achieved.

One example of a nozzle reactor for altering the physical or chemical composition of materials injected therein is shown in FIG. 3 of the U.S. Pat. No. 6,989,091. The nozzle reactor discussed in the '091 patent has two steam injectors and a central feed stock injector, each of which includes a discharge end feeding into a central reactor tube. The two steam injectors are disposed (i) laterally separated from opposing sides of the central feed stock injector and (ii) at an acute angle to the axis of the central feed stock injector. The steam injectors are thus disposed for injection of material into the central reactor tube in the direction of travel of material feed stock injected into the central reactor tube by the central feed stock injector. The central feed stock injector is coaxial with the central reactor tube and has a generally straight-through bore.

As explained in the '091 patent, superheated steam is injected through the two laterally opposed steam injectors into the interior of central reactor tube in order to impact a pre-heated, centrally-located feed stream of certain types of heavy hydrocarbon simultaneously injected into the interior of the central reactor tube via the central feed stock injector. The '091 patent states that the object of disclosed nozzle reactor is to crack the feed stream into lighter hydrocarbons through the impact of the steam feeds with the heavy hydrocarbon feed within the reactor tube. According to the '091 patent, the types of heavy hydrocarbons processed with the disclosed nozzle reactor are crude oil, atmospheric residue, and heavy distillates. With the nozzle reactor of the '091 patent, a central oil feed stock jet intersects the steam jets at some distance from the ejection of these jets from their respective injectors.

In some embodiments of the nozzle reactor disclosed in the '091 patent, a portion of the lighter hydrocarbons produced by cracking heavy hydrocarbon in the nozzle reactor do not meet certain standards for nozzle reactor product. For example, a liquid heavy oil product produced by the nozzle reactor can have a molecular weight greater than the desired maximum molecular weight for the hydrocarbon products. Accordingly, the '091 patent discloses that a recycle stream may be used in order to recycle these hydrocarbon products back into the nozzle reactor. However, the '091 patent appears to only consider such a recycle stream for cracked hydrocarbon products of the nozzle reactor. The '091 patent appears to be silent with respect to recycling any un-cracked solid residue (pitch) product produced by the nozzle reactor. In Applicant's experience, failure to consider recycle of solid residue is not surprising, as conventional understanding of nozzle reactor technology has generally suggested that solid pitch material exiting a nozzle reactor will not be broken down by recycling it back through a nozzle reactor.

Applicants believe that one disadvantage of the nozzle reactor disclosed in the '091 patent is the amount of heavy hydrocarbon that passes through the nozzle reactor un-cracked. Applicants believe this is due to the near impossibility of cracking all material having a boiling temperature greater than 1,050° F. (565° C.) into material having a boiling temperature less than 1,050° F. when the operating temperature of the nozzle reactor is substantially lower than 1,050° F. and the reaction time in the nozzle reactor is around a few seconds or less.

The disadvantage of a large quantity of un-cracked material passing through the nozzle reactor in the '091 patent is further exacerbated by the apparent failure of the reference to provide any manner in which the nozzle reactor may further process such un-cracked material. If no further nozzle reactor processing is carried out on the un-cracked heavy hydrocarbons, then the efficiency and profitability of the nozzle reactor may be diminished. Even if conventional methods for processing the un-cracked heavy hydrocarbons are relied upon, such as processing the un-cracked heavy hydrocarbon in a coker unit, then the overall cost and complexity of the process may be increased.

### SUMMARY

Disclosed below are representative embodiments that are not intended to be limiting in any way. Instead, the present disclosure is directed toward features, aspects, and equivalents of the embodiments of the method and systems described below. The disclosed features and aspects of the embodiments can be used alone or in various combinations and sub-combinations with one another.

In some embodiments a method of cracking hydrocarbon material in a nozzle reactor and processing pitch produced therefrom is described. The method may include providing a nozzle reactor. The nozzle reactor may include a reactor body, a first material injector and a second material feed port. The reactor body may include an injection end and an ejection end. The first material injector may include a first material injection passage and may be mounted in the nozzle reactor in material injecting communication with the injection end of the reactor body. The first material injection passage may include an enlarged volume injection section, an enlarged volume ejection section, and a reduced volume mid-section intermediate the enlarged volume injection section and enlarged volume ejection section. The first material injection passage may also include a material injection end and a material ejection end in injecting communication with the reactor body passage. The second material feed port may be adjacent to the material ejection end of the first material injection passage. The method may also include injecting a stream of cracking material through the first material injector into the reactor body and injecting hydrocarbon material through the second material feed port into the reactor body. The method may further include collecting the heavy hydrocarbon fraction exiting the nozzle reactor and injecting the heavy hydrocarbon fraction into the reactor body.

In some embodiments, the method may include collecting a first nozzle reactor heavy hydrocarbon fraction exiting a first nozzle reactor. The method may also include providing a second nozzle reactor. The second nozzle reactor may include a reactor body, a first material injector and a second material feed port. The reactor body may include an injection end and an ejection end. The first material injector may include a first material injection passage and may be mounted in the nozzle reactor in material injecting communication with the injection end of the reactor body. The first material injection passage may include an enlarged volume injection section, an enlarged volume ejection section, and a reduced volume mid-section intermediate the enlarged volume injection section and enlarged volume ejection section. The first material injection passage may also include a material injection end and a material ejection end in injecting communication with the reactor body passage. The second material feed port may be adjacent to the material ejection end of the first material injection passage. The method may also include injecting a stream of cracking material through the first material injector into the reactor body and injecting the first nozzle reactor heavy hydrocarbon fraction through the second material feed port into the reactor body. The method may also include collecting a second nozzle reactor heavy hydrocarbon fraction exiting the second nozzle reactor and injecting the second nozzle reactor heavy hydrocarbon fraction into the reactor body.

In some embodiments, a nozzle reactor is described. The nozzle reactor may include a include a reactor body, a first material injector, a second material feed port, and an un-cracked material recycle passage. The reactor body may include an injection end and an ejection end. The first material injector may include a first material injection passage and may be mounted in the nozzle reactor in material injecting communication with the injection end of the reactor body. The first material injection passage may include an enlarged volume injection section, an enlarged volume ejection section, and a reduced volume mid-section intermediate the enlarged volume injection section and enlarged volume ejection section. The first material injection passage may also include a material injection end and a material ejection end in injecting communication with the reactor body passage. The second material feed port may be adjacent to the material ejection end of the first material injection passage. The un-cracked material recycle passage may have a first end and a second end. The first end may be in material receiving communication with the ejection end of the reactor body passage. The second end may be in material injecting communication with the reactor body passage at a location adjacent the material ejection end of the first material injection passage.

The foregoing and other features and advantages of the present application will become apparent from the following detailed description, which proceeds with reference to the accompanying figures. It is thus to be understood that the scope of the invention is to be determined by the claims as issued and not by whether a claim includes any or all features or advantages recited in this Summary or addresses any issue identified in the Background.

### BRIEF DESCRIPTION OF THE DRAWINGS

The preferred and other embodiments are disclosed in association with the accompanying drawings in which:

FIG. 1 is a flow diagram of an embodiment of one method described herein;

FIG. 2 is a cross-sectional, schematic view of one embodiment of a nozzle reactor;

FIG. 3 is a cross-sectional view of the nozzle reactor of FIG. 1, showing further construction details for the nozzle reactor;

FIG. 4 is a schematic diagram of one embodiment of a system described herein;

FIG. 5 is a schematic diagram of one embodiment of a system described herein; and

FIG. 6 is a series of photographs showing the embodiments of the solid pitch obtained from the nozzle reactor after a first pass, a first recycle and a second recycle.

### DETAILED DESCRIPTION

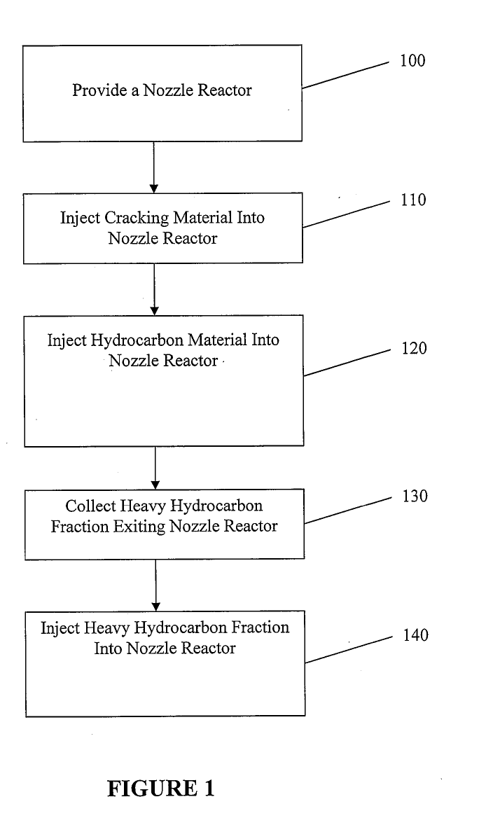

With reference to FIG. 1, a method for cracking hydrocarbon material and processing any un-cracked heavy hydrocarbon material (also referred to as “pitch”) may generally include a step 100 of providing a nozzle reactor, a step 110 of injecting cracking material into the nozzle reactor, a step 120 of injecting hydrocarbon material into the nozzle reactor, a step 130 of collecting a heavy hydrocarbon fraction exiting the nozzle reactor, and a step 140 of injecting the heavy hydrocarbon fraction into the nozzle reactor. The heavy hydrocarbon fraction may include the highest molecular weight hydrocarbon compounds present in the original hydrocarbon material that remain un-cracked after passing through the nozzle reactor. Typically, such compounds may constitute a pitch by-product that requires either disposal (resulting in a waste of hydrocarbon material) or processing in supplementary processing equipment, such as a coker (which may increase the overall cost and complexity of the operation). However, in the method described herein, the heavy hydrocarbon fraction may be injected back into the nozzle reactor in order to crack the heavy hydrocarbon compounds into lighter hydrocarbon molecules. In some embodiments, recycling the heavy hydrocarbon fraction back into the nozzle reactor (or recycling the heavy hydrocarbon fraction in a second nozzle reactor) may increase the overall conversion of heavy hydrocarbon compounds being passed therethrough into lighter hydrocarbon compounds.

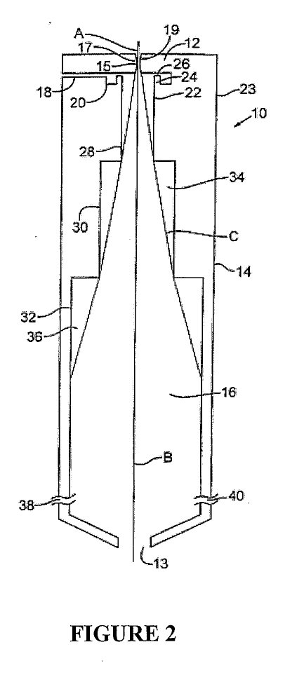

The method may include a step 100 of providing a nozzle reactor. As described above, some nozzle reactors may generally be used to cause interactions between materials and achieve alteration of the physical or chemical composition of one or more of the materials. With reference to FIG. 2, a nozzle reactor suitable for use in the method described herein and indicated generally at 10 may have a reactor body injection end 12, a reactor body 14 extending from the reactor body injection end 12, and an ejection port 13 in the reactor body 14 opposite its injection end 12. The reactor body injection end 12 may include an injection passage 15 extending into the interior reactor chamber 16 of the reactor body 14. The central axis A of the injection passage 15 may be coaxial with the central axis B of the interior reactor chamber 16.

With continuing reference to FIG. 2, the injection passage 15 may have a circular diametric cross-section and, as shown in the axially-extending cross-sectional view of FIG. 2, opposing inwardly curved side wall portions 17, 19 (i.e., curved inwardly toward the central axis A of the injection passage 15) extending along the axial length of the injection passage 15. In certain embodiments, the axially inwardly curved side wall portions 17, 19 of the injection passage 15 may allow for a higher speed of cracking material when passing through the injection passage 15 into the interior reactor chamber 16.

In certain embodiments, the side wall of the injection passage 15 can provide one or more among: (i) uniform axial acceleration of cracking material passing through the injection passage; (ii) minimal radial acceleration of such cracking material; (iii) a smooth finish; (iv) absence of sharp edges; and (v) absence of sudden or sharp changes in direction. The side wall configuration can render the injection passage 15 substantially isentropic. These latter types of side wall and injection passage features can be, among other things, particularly useful for pilot plant nozzle reactors of minimal size.

A material feed passage 18 may extend from the exterior of the reactor body 14 toward the interior reactor chamber 16. In the embodiment shown in FIG. 2, the material feed passage 18 may be aligned transversely to the axis A of the injection passage 15, although other configurations may be used. The material feed passage 18 may penetrate an annular material feed port 20 adjacent the interior reactor chamber wall 22 at the interior reactor chamber injection end 24 abutting the reactor body injection end 12. The material feed port 20 may include an annular, radially extending reactor chamber feed slot 26 in material-injecting communication with the interior reactor chamber 16. The material feed port 20 may thus be configured to inject feed material: (i) around the entire circumference of a cracking material injected through the injection passage 15; and (i) to impact the entire circumference of the free cracking material stream virtually immediately upon its emission from the injection passage 15 into the interior reactor chamber 16. As noted above, the material feed port 20 may also inject feed material at about a 90° angle to the axis of travel of cracking material injected from the injection passage 15, although other angles greater than or less than 90° may also be used.

The annular material feed port 20 may have a U-shaped or C-shaped cross-section among others. In certain embodiments, the annular material feed port 20 may be open to the interior reactor chamber 16, with no arms or barriers in the path of fluid flow from the material feed passage 18 toward the interior reactor chamber 16. The junction of the annular material feed port 20 and material feed passage 18 can have a radiused cross-section.

In alternative embodiments, the material feed passage 18, annular material feed port 20, and/or injection passage 15 may have differing orientations and configurations, and there can be more than one material feed passage and associated structure. Similarly, in certain embodiments the injection passage 15 may be located on or in the interior reactor chamber side 23 (and if desired may include an annular cracking material port) rather than at the reactor body injection end 12 of the reactor body 14, and the annular material feed port 20 may be non-annular and located at the reactor body injection end 12 of the reactor body 14.

In the embodiment shown in FIG. 2, the interior reactor chamber 16 can be bounded by stepped, telescoping side walls 28, 30, 32 extending along the axial length of the reactor body 14. In certain embodiments, the stepped side walls 28, 30, 32 may be configured to: (i) allow a free jet of injected cracking material, such as superheated steam, natural gas, carbon dioxide, or other gas, to travel generally along and within the conical jet path C generated by the injection passage 15 along the axis B of the interior reactor chamber 16, while (ii) reducing the size or involvement of back flow areas, e.g., 34, 36, outside the conical or expanding jet path C, thereby forcing increased contact between the high speed cracking material jet stream within the conical jet path C and feed material, such as hydrocarbon material, injected through the annular material feed port 20.

As indicated by the drawing gaps 38, 40 in the embodiment shown in FIG. 2, the reactor body 14 may have an axial length (along axis B) that is much greater than its width. In the embodiment shown in FIG. 2, exemplary length-to-width ratios may typically be in the range of 2 to 4 or more.

The dimensions of the various components of the nozzle reactor shown in FIG. 2 are not limited, and may generally be adjusted based on the amount of hydrocarbon material to be cracked inside the nozzle reactor. Table 1 provides exemplary dimensions for the various components of the nozzle reactor based on the hydrocarbon material input in barrels per day (BPD). The dimensions provided in Table 1 are not exhaustive for the given hydrocarbon input rate, as other dimensions may be used for hydrocarbon inputs of 5,000 BPD, 10,000 BPD and 20,000 BPD.

TABLE 1

| | Hydrocarbon Input, 000′ kg | | |
|---|---|---|---|
| | (BPD) | | |
| | 790 | 1,580 | 3,160 |
| Nozzle Reactor Component (mm) | (5,000) | (10,000) | (20,000) |
| Injection Passage, Enlarged Volume | 148 | 207 | 295 |
| Injection Section Diameter | | | |
| Injection Passage, Reduced Volume | 50 | 70 | 101 |
| Mid-Section Diameter | | | |
| Injection Passage, Enlarged Volume | 105 | 147 | 210 |
| Ejection Section Diameter | | | |
| Injection Passage Length | 600 | 840 | 1,200 |
| Interior Reactor Chamber Injection End | 187 | 262 | 375 |
| Diameter | | | |
| Interior Reactor Chamber Ejection End | 1,231 | 1,435 | 1,821 |
| Diameter | | | |
| Interior Reactor Chamber Length | 6,400 | 7,160 | 8,800 |
| Overall Nozzle Reactor Length | 7,000 | 8,000 | 10,000 |
| Overall Nozzle Reactor Outside | 1,300 | 1,600 | 2,000 |
| Diameter | | | |

As can be seen from Table 1, the injection passage may be small relative to the reactor body. The relatively small size of the injection passage is beneficial in that the injection passage may be part of a replaceable insert that is easily removed from the reactor body. Accordingly, other injection passages having different internal dimensions and providing different types of injection flow properties for the cracking material may be used to increase the versatility of the nozzle reactor as a whole.

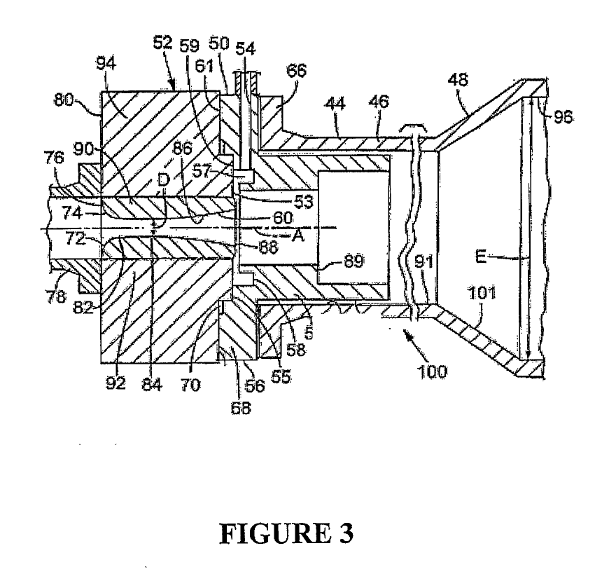

With reference now to FIG. 3 and the particular embodiment shown therein, the reactor body 44 may include a generally tubular central section 46 and a frustoconical ejection end 48 extending from the central section 46 opposite an insert end 50 of the central section 46, with the insert end 50 in turn abutting the injection nozzle 52. The insert end 50 of the central section 46 may consist of a generally tubular central body 51. The central body 51 may have a tubular material feed passage 54 extending from the external periphery 56 of the insert end 50 radially inwardly to injectingly communicate with the annular circumferential feed port depression or channel 58 in the otherwise planar, radially inwardly extending portion 59 of the axially stepped face 61 of the insert end 50. The inwardly extending portion 59 may abut the planar radially internally extending portion 53 of a matingly stepped face 55 of the injection nozzle 52. The feed port channel 58 and axially opposed radially internally extending portion 53 of the injection nozzle 52 may cooperatively provide an annular feed port 57 disposed generally radially outwardly from the axis A of a preferably non-linear injection passage 60 in the injection nozzle 52.

The tubular body 51 of the insert end 50 may be secured within and adjacent to the interior periphery 64 of the reactor body 44. The mechanism for securing the insert end 50 in this position may consist of an axially-extending nut-and-bolt arrangement (not shown) penetrating co-linearly mating passages (not shown) in: (i) an upper radially extending lip 66 on the reactor body 44; (ii) an abutting, radially outwardly extending thickened neck section 68 on the insert end 50; and (iii) in turn, the abutting injector nozzle 52. Other mechanisms for securing the insert end 50 within the reactor body 44 may include a press fit (not shown) or mating threads (not shown) on the outer periphery 62 of the tubular body 51 and on the inner periphery 64 of the reactor body 44. Seals, e.g., 70, may be mounted as desired between, for example, the radially extending lip 66 and the abutting the neck section 68 and the neck section 68 and the abutting injector nozzle 52.

The non-linear injection passage 60 may have, from an axially-extending cross-sectional perspective, mating, radially inwardly curved opposing side wall sections 72, 74 extending along the axial length of the non-linear injection passage 60. The entry end 76 of injection passage 60 may provide a rounded circumferential face abutting an injection feed tube 78, which can be bolted (not shown) to the mating planar, radially outwardly extending distal face 80 on the injection nozzle 52.

In the embodiment shown in FIG. 3, the injection passage 60 may be a DeLaval type of nozzle and have an axially convergent section 82 abutting an intermediate relatively narrower throat section 84, which in turn abuts an axially divergent section 86. The injection passage 60 may also have a circular diametric cross-section (i.e., in cross-sectional view perpendicular to the axis of the nozzle passage) all along its axial length. In certain embodiments, the injection passage 60 may also present a somewhat roundly curved thick 82, less curved thicker 84, and relatively even less curved and more gently sloped relatively thin 86 axially extending cross-sectional configuration from the entry end 76 to the injection end 88 of the injection passage 60 in the injection nozzle 52.

The injection passage 60 can thus be configured to present a substantially isentropic or frictionless configuration for the injection nozzle 52. This configuration may vary, however, depending on the application involved in order to yield a substantially isentropic configuration for the application.

The injection passage 60 may be formed in a replaceable injection nozzle insert 90 press-fit or threaded into a mating injection nozzle mounting passage 92 extending axially through an injection nozzle body 94 of the injection nozzle 52. The injection nozzle insert 90 may preferably be made of hardened steel alloy, and the balance of the nozzle reactor 100 components other than seals, if any, may preferably be made of steel or stainless steel.

In the particular embodiment shown in FIG. 3, the diameter D within the injection passage 60 is 140 mm. The diameter E of the ejection passage opening 96 in the ejection end 48 of the reactor body 44 is 2.2 meters. The axial length of the reactor body 44, from the injection end 88 of the injector passage 60 to the ejection passage opening 96, is 10 meters. These dimensions are not exhaustive, as other dimensions may be used.

The interior peripheries 89, 91 of the insert end 50 and the tubular central section 46, respectively, may cooperatively provide a stepped or telescoped structure expanding radially outwardly from the injection end 88 of the injection passage 60 toward the frustoconical end 48 of the reactor body 44. The particular dimensions of the various components, however, will vary based on the particular application for the nozzle reactor, generally 100. Factors taken into account in determining the particular dimensions may include the physical properties of the cracking gas (density, enthalpy, entropy, heat capacity, etc.) and the pressure ratio from the entry end 76 to the injection end 88 of the injection passage 60.

Other embodiments of nozzle reactors suitable for use in the method described herein are set forth in commonly owned, co-pending U.S. application Ser. No. 12/245,036, which is hereby incorporated by reference.

The nozzle reactor provided at step 100 may be used to crack hydrocarbon material into lighter hydrocarbons and other components. In order to do so in certain embodiments, a cracking material and a hydrocarbon material may be injected into the nozzle reactor. The collision of the injected hydrocarbon material with the high speed and high temperature cracking material may deliver kinetic and thermal energy to the hydrocarbon material and result in the cracking of the largest hydrocarbon molecules. The applicants believe that this process may continue, but with diminished intensity and productivity, through the length of the reactor body 44 as injected hydrocarbon material is forced along the axis of the reactor body 44 and yet constrained from avoiding contact with the cracking material jet stream by the telescoping interior walls, e.g., 89, 91 101, of the reactor body 44.

In view of the above described mechanism for cracking hydrocarbon material inside a nozzle reactor, the method may include a step 110 of injecting cracking material into the nozzle reactor and a step 120 of injecting hydrocarbon material into the nozzle reactor.

Referring first to step 110 and with reference to FIG. 2, the cracking material may be injected into the interior reactor chamber 16 of the nozzle reactor via the injection passage 15. The configuration of the injection passage 15 may provide for the acceleration of the cracking material as it passes through the injection passage 15. With reference to FIG. 3, the pressure differential from the entry end 76 of the injection passage 60, where the pressure is relatively high, to the ejection end 88 of the injection passage 60, where the pressure is relatively low, may aid in accelerating the cracking material through the injection passage 60. In certain embodiments having one or more non-linear cracking material injection passages 60, the pressure differential can yield a steady increase in the kinetic energy of the cracking material as it moves along the length of the cracking material injection passage(s) 60. The cracking material may thereby eject from the ejection end 88 of the injection passage 60 into the interior of the reactor body 44 at supersonic speed with a commensurately relatively high level of kinetic energy.

Other embodiments of a cracking material injection passage may not be as isentropic but may provide a substantial increase in the speed and kinetic energy of the cracking material as it moves through the injection passage 60. For example, an injection passage 60 may comprise a series of conical or toroidal sections (not shown) to provide varying cracking material acceleration through the injection passage 60 and, in certain embodiments, supersonic discharge of the cracking material from the passage 60.

The cracking material injected into the nozzle reactor at step 110 may be any suitable material for cracking hydrocarbon. In some embodiments, the cracking material is in the form of a gas, such as steam. Other suitable gasses include, but are not limited to, carbon dioxide, and natural gas.

The cracking material entering the injection passage may be pre-treated, such as be pre-heating the cracking material. In some embodiments, the cracking material may be pre-heated to a temperature in the range of from about 350° C. to about 750° C. The pressure of the cracking material may also be adjusted. In some embodiments, the pressure of the cracking material prior to injection into the injection passage may range from about 5 bar to about 100 bar (gage pressure).

The cracking material exiting the injection passage and entering the reaction chamber may have a temperature in the range of from about 0° C. to about 600° C. and may have a pressure in the range of from about 0 bar to about 15 bar (gage pressure). Furthermore, the velocity of the cracking material as it exits the injection passage may range from about Mach 1 to Mach 5.

The amount of cracking material introduced into the injection passage may vary. In some embodiments, the amount of cracking material introduced into the injection passage may vary from about 0.25 to about 4.0 times the amount (weight basis) of hydrocarbon material injected into the nozzle reactor as described in greater detail below.

Referring now to step 120, hydrocarbon material may also be injected into the nozzle reactor. In some embodiments, the hydrocarbon material may be injected into the interior reactor chamber 16 of the nozzle reactor via the material feed passage 18. With reference to FIG. 3, the material feed passage 54 may be oriented in a direction perpendicular to the injection passage 60, although other orientations may be used. In the perpendicular configuration, the hydrocarbon material may thereby travel radially inwardly to impact a transversely (i.e., axially) traveling high speed cracking material virtually immediately upon its ejection from the ejection end 88 of the injection passage 60.

The type of hydrocarbon material injected into the nozzle reactor at step 120 is not limited. In some embodiments, the hydrocarbon material injected into the nozzle reactor has an average molecular weight of greater than about 300 Dalton. In some embodiments, the hydrocarbon material may include bitumen. The hydrocarbon material may also include asphaltene. The hydrocarbon material may also be any mixture of materials that includes various types of hydrocarbons and other materials. In some embodiments, the hydrocarbon material is hydrocarbon material collected from a refinery processing operation. For example, the hydrocarbon material may be residual oil produced by any type of refinery processing operation, such as distillation, coking, hydrocracking, hydrotreating, and solvent deasphalting. Residual oil is described in greater detail in commonly owned, co-pending U.S. Provisional Application No. 61/169,569.

The hydrocarbon material injected into the nozzle reactor at step 120 may be pretreated prior to injection. In some embodiments, the hydrocarbon material may be pre-heated. In some embodiments, the preheat may provide an injection temperature of from about 300° C. to about 450° C., and more preferably, from about 390° C. to about 430° C. Pre-heating may take place at a pressure similar to the pressure inside of the nozzle reactor. In some embodiments, the pre-heating may therefore take place at range of from about 2 bar to about 17 bar (which is generally a slightly higher pressure than that in the reactor body 44).

The amount of hydrocarbon material injected into the nozzle reactor is not limited. In some embodiments, the amount of hydrocarbon material injected into the nozzle reactor depends on the size of the nozzle reactor.

In some embodiments, the amount of hydrocarbon material injected into the nozzle reactor determines the amount of cracking material injected into the nozzle reactor. In some embodiments, the amount of cracking material injected in the nozzle reactor is from about 0.25 to about 4.0 times the amount (by weight) of hydrocarbon material injected into the nozzle reactor.

The retention time of the hydrocarbon material in the reactor body zone may be relatively short. In some embodiments, the retention time is in the range of from about 0.1 seconds to about 30 seconds. For example, the retention time of the hydrocarbon material in the reactor body may be about 1.0 seconds.

It is generally theorized that nozzle reactor as described herein preferentially cracks molecules having the largest molecular mass over molecules having smaller molecular mass. Applicants believe this is due in part to the higher boiling point temperature of the larger hydrocarbon molecules. The larger hydrocarbon molecules are more likely to be in a liquid state upon injection into the nozzle reactor due to the higher boiling point temperatures, and consequently, are more likely to be cracked by, e.g., the shockwaves produced by injecting the cracking material into the nozzle reactor at a supersonic speed. Conversely, the molecules having a smaller molecular mass may be present in the nozzle reactor in a gaseous state, thus making it less likely that the shockwaves will crack the molecules. In some embodiments, the smaller molecules may pass through the nozzle reactor unaltered.

Table 2 shows the approximate percent gain or loss of various hydrocarbon components of a hydrocarbon material that can be achieved in certain embodiments after a single pass through a nozzle reactor as described herein.

TABLE 2

| Hydrocarbon Molecule | Percent Change |
|---|---|
| C₇ Insoluble Asphaltene | Loss >> 75% |
| C₅ Insoluble Asphaltene | Loss > 50% |
| Resins | Loss > 50% |
| Aromatics | Gain > 50% |
| Saturates | Gain > 20% |

As can be seen from Table 2, the largest hydrocarbon molecules (C₇ asphaltene) of the hydrocarbon material tend to be lost at the greatest rate. The loss of these molecules may be due to the cracking of the large hydrocarbon molecules into smaller aromatics and saturates. This may also explain the increase in the amount of aromatics and saturates after the hydrocarbon material has been passed through the nozzle reactor.

Ultimately, the material exiting the nozzle reactor may be a combination of cracked and un-cracked hydrocarbon molecules. As noted above, the un-cracked material may include some of the smaller hydrocarbon molecules that passed through the nozzle reactor un-cracked. However, the un-cracked material may also include larger hydrocarbon materials that were not cracked in the nozzle reactor, possibly as a result of the short residence time of the hydrocarbon material in the reactor body. The larger hydrocarbon molecules that exit the nozzle reactor un-cracked may constitute a heavy hydrocarbon fraction. Because the molecules of the heavy hydrocarbon fraction are primarily un-cracked large hydrocarbon molecules, the heavy hydrocarbon fraction essentially represents unprocessed hydrocarbon material that has limited commercial usefulness. In conventional methods, heavy hydrocarbon fractions may have either been discarded or subjected to further processing by additional processing equipment. However, in the method described herein, the heavy hydrocarbon fraction may be re-injected into the nozzle reactor in order to crack the large hydrocarbon molecules into lighter, more useful, hydrocarbon molecules.

Accordingly, the method may further include a step 130 of collecting the heavy hydrocarbon fraction so that the heavy hydrocarbon fraction may be re-injected into a nozzle reactor. Any suitable manner of collecting the heavy hydrocarbon fraction may be used. In some embodiments, all of the material exiting the nozzle reactor may be collected, and then the heavy hydrocarbon fraction may be separated from the rest of the material exiting the nozzle reactor. The heavy hydrocarbon fraction may be separated according to any method well known to those of ordinary skill in the art, including any separation method based on the physical properties of the collected hydrocarbon material (e.g., boiling point temperature).

The exact composition of the heavy hydrocarbon fraction collected in step 130 may vary based on a variety of factors. In some embodiments, the composition of the heavy hydrocarbon fraction will at least partially depend on the hydrocarbon material. For example, where the hydrocarbon material is bitumen, the heavy hydrocarbon fraction may include un-cracked C₇ or C₅ insoluble asphaltene because the C₅ and C₇ insoluble asphaltenes are amongst the heaviest hydrocarbon molecules present in bitumen. In some embodiments, the composition of the heavy fraction will at least partially depend on a user-defined property for establishing the heavy hydrocarbon fraction. For example, a minimum boiling point temperature may be selected, above which all hydrocarbon molecules are included in the heavy hydrocarbon fraction. However, generally speaking, the heavy hydrocarbon fraction may include hydrocarbon molecules exiting the nozzle reactor having a boiling point temperature above 1,050° F. (565° C.) or hydrocarbon molecules leaving the nozzle reactor having a molecular weight greater than 500 Daltons.

Once the heavy hydrocarbon fraction has been collected, the method may include a step 140 of injecting the heavy hydrocarbon fraction into the nozzle reactor. In some embodiments, the heavy hydrocarbon fraction may be injected into the nozzle reactor at a direction transverse to the cracking material entering the nozzle reactor, although other non-transverse injection paths may be used. The heavy hydrocarbon material may be injected into the nozzle reactor in any suitable fashion. In some embodiments, the heavy hydrocarbon material may be injected into the nozzle reactor via the material feed passage 18. A separate injection passage may also exist for injection of the heavy hydrocarbon fraction into the nozzle reactor. Like material feed passage 18, any additional injection passage may inject the heavy hydrocarbon fraction into the nozzle reactor. It is also preferable that any additional injection passage inject the heavy hydrocarbon fraction into the nozzle reactor such that the injected heavy hydrocarbon fraction will intersect with the cracking material at a location approximate injection passage ejection end (i.e., where the cracking material enters the reactor body).

When the heavy hydrocarbon material is injected into the nozzle reactor via the feed material passage 18, the heavy hydrocarbon fraction may be injected into the nozzle reactor together with hydrocarbon material. For example, the heavy hydrocarbon fraction and the hydrocarbon material may be pre-mixed prior to injection into the nozzle reactor. When the hydrocarbon material and the heavy hydrocarbon fraction are injected together, the amount and concentration of the heavy hydrocarbon fraction in the nozzle reactor feed may be increased. An increase in the amount and concentration of heavy hydrocarbon fraction in the nozzle reactor feed may result in an overall increase in the cracking of heavy hydrocarbon fraction. For example, when the hydrocarbon material includes bitumen and the heavy hydrocarbon fraction includes C₅ and C₇ insoluble asphaltenes, injecting the heavy hydrocarbon fraction with the hydrocarbon material increases the amount and concentration of C₅ and C₇ insoluble asphaltenes in the nozzle reactor feed and may result in an increased conversion of C₅ and C₇ insoluble asphaltenes into lighter hydrocarbon molecules than if hydrocarbon material alone is injected into the nozzle reactor. Table 3 illustrates the approximate increase in conversion of heavy hydrocarbons into lighter hydrocarbons when the concentration and amount of heavy hydrocarbon fraction is increased in the nozzle reactor.

TABLE 3

| | Percent Change | |
|---|---|---|
| | Without Heavy | With |
| | Hydrocarbon Fraction | Heavy Hydrocarbon |
| Hydrocarbon Molecule | Recycle | Fraction Recycle |
| C₇ Insoluble Asphaltene | Loss > 75% | Loss > 95% |
| C₅ Insoluble Asphaltene | Loss > 50% | Loss > 75% |
| Resins | Loss > 50% | Loss > 75% |
| Aromatics | Gain > 50% | Gain > 75% |
| Saturates | Gain > 20% | Gain > 35% |

When the heavy hydrocarbon fraction is injected into the nozzle reactor via an injection passage separate from the material feed passage, the heavy hydrocarbon fraction may still be injected into the nozzle reactor at the same time as hydrocarbon material entering via the material feed passage. In this manner, the amount and concentration of the heavy hydrocarbon fraction may still be increased and result in an increased conversion of heavy hydrocarbon material into lighter hydrocarbon molecules.

Heavy hydrocarbon fraction need not be injected into the nozzle reactor together with additional hydrocarbon material. In some embodiments, the recycled heavy hydrocarbon fraction is the only material injected into the nozzle reactor. In such embodiments, any supply of hydrocarbon material being injected into the nozzle reactor via the material feed passage may be stopped prior to the injection of heavy hydrocarbon fraction back into the nozzle reactor.

In some embodiments, the injection of heavy hydrocarbon fraction into the nozzle reactor may be accomplished via an un-cracked material recycle passage. The un-cracked material recycle passage may be any type of passage capable of transporting the heavy hydrocarbon fraction leaving the nozzle reactor back into the nozzle reactor, such as tubing or piping. The dimensions and materials of the un-cracked material recycle passage are generally not limited and may be selected according to dimensions and operating conditions of the nozzle reactor. In some embodiments, the material of the un-cracked material recycle passage is selected so that no material passing therethrough can pass through the walls of the un-cracked material recycle passage.

The un-cracked material recycle passage may have a first end and a second end opposite the first end. The first end may be in material receiving communication with the ejection end of the reactor body passage of the nozzle reactor. In some embodiments, the separation unit for separating the heavy hydrocarbon fraction from the rest of the material exiting the nozzle reactor may be located intermediate of the ejection end of the reactor body passage and the first end of the un-cracked material recycle passage. In such a configuration, the un-cracked material recycle passage may receive predominantly or only the heavy hydrocarbon fraction separated from the remainder of the material exiting the nozzle reactor by the separation unit. The second end of the un-cracked material recycle passage may be in material injecting communication with the nozzle reactor such that the heavy hydrocarbon fraction passing therethrough may eventually be re-injected into the nozzle reactor. In some embodiments, the second end of the un-cracked material recycle passage is located adjacent the ejection end of the injection passage so that the cracking material may impact the heavy hydrocarbon fraction immediately upon injection into the nozzle reactor. In some embodiments, the second end of the uncracked material recycle passage may be in material injecting communication with the material feed passage. The second end of the uncracked material recycle passage may be aligned with the nozzle reactor such that the heavy hydrocarbon fraction is injected into the nozzle reactor at a direction transverse to the direction the cracking material is injected into the nozzle reactor, although other non-transverse configurations are also possible.

Once heavy hydrocarbon fraction and cracking material have been injected into the nozzle reactor and cracking of the hydrocarbon molecules commences, the nozzle reactor will again emit a mixture of cracked and un-cracked material. While the overall cracking rate of the large hydrocarbon molecules that make up the heavy hydrocarbon fraction may increase, an amount of un-cracked large hydrocarbon molecules may still be produced. Accordingly, steps 130 and 140 may be repeated. In a repeat of step 130, the un-cracked large hydrocarbon molecules may be collected as part of a heavy hydrocarbon fraction. In a repeat of step 140, the heavy hydrocarbon fraction may be re-injected into the nozzle reactor to further crack the large hydrocarbon molecules.

Steps 130 and 140 may be repeated any number of times. In some embodiments, the heavy hydrocarbon fraction will disappear altogether after a certain number of recycle steps. Progress towards total cracking of the heavy hydrocarbon molecules may be observed by measuring the hardness of the heavy hydrocarbon fraction collected after each pass through the nozzle reactor. In some embodiments, the first amount of heavy hydrocarbon fraction collected after a first pass of the hydrocarbon material through the nozzle reactor may have a crumbly, dusty, and hard consistency. After this material is injected back into the nozzle reactor, the second amount of heavy hydrocarbon fraction collected may have a visco-elastic consistency. After the visco-elastic heavy hydrocarbon fraction is injected back into the nozzle reactor, the third amount of heavy hydrocarbon fraction collected may have the consistency of a high viscosity fluid. Applicants believe that this continuous change in the consistency of the heavy hydrocarbon fraction from a crumbly solid to an essentially liquid material is evidence of the increased rate of heavy hydrocarbon fraction cracking with every pass and the eventual elimination of any “pitch” by-product.

The heavy hydrocarbon fraction collected from the nozzle reactor may require pretreatment prior to re-injection into the nozzle reactor. For example, in the case where the heavy hydrocarbon fraction collected has a crumbly, dusty and hard consistency, the heavy hydrocarbon may need to be mixed with another material to put the heavy hydrocarbon fraction in a condition that will allow for transport through the un-cracked material recycle passage and for injection into the nozzle reactor. Any suitable type of material may be used to put the heavy hydrocarbon fraction in a more flowable or injectable condition. In some embodiments, the heavy hydrocarbon material may be mixed with the hydrocarbon material prior to injection into the nozzle reactor. The hydrocarbon material may be in a liquid form at a high temperature from the separation process, thereby making the mixture of hydrocarbon material and heavy hydrocarbon fraction flowable and injectable. Other pre-treatment steps, such as pre-heating, may also be preformed on the heavy hydrocarbon fraction where necessary.

In some embodiments, heavy hydrocarbon fraction collected at step 130 may be injected into a second nozzle reactor. The second nozzle reactor may be generally dedicated to processing of the heavy hydrocarbon fraction. The second nozzle reactor may have a similar configuration as the nozzle reactor described above, but the second nozzle reactor may be used specifically for receiving the heavy hydrocarbon fraction from the first nozzle reactor and any further heavy hydrocarbon fraction exiting the second nozzle reactor (via the recycle stream). In such embodiments, the collected heavy hydrocarbon fraction may be injected into the second nozzle reactor via a material feed passage or other similar injection passage as described previously with respect to the injection of the heavy hydrocarbon fraction into the first nozzle reactor. In some embodiments, the only hydrocarbon material injected into the second nozzle reactor is heavy hydrocarbon fraction. In other words, no other hydrocarbon material is injected into the second nozzle reactor together with the heavy hydrocarbon fraction.

A cracking material may also be injected into the second nozzle reactor as described in greater detail above with respect to the first nozzle reactor. In some embodiments, the heavy hydrocarbon fraction may be injected into the nozzle reactor at a direction transverse to the direction the cracking material enters the nozzle reactor. The cracking material may be similar or identical to the cracking material described above, and in some embodiments, the cracking material includes steam.

The heavy hydrocarbon fraction may be cracked inside of the second nozzle reactor by shockwaves produced by the cracking material injected and expanded into the nozzle reactor. Accordingly, the second nozzle reactor may emit cracked hydrocarbons. However, as with the first nozzle reactor, not all heavy hydrocarbon fractions may be cracked inside of the nozzle reactor. Therefore, the heavy hydrocarbon fraction exiting the nozzle reactor may be collected and re-injected into the second nozzle reactor. Collection of the heavy hydrocarbon fraction exiting the second nozzle reactor may be similar or identical to the collection of the heavy hydrocarbon fraction exiting the first nozzle reactor as discussed in greater detail above.

The manner in which the heavy hydrocarbon fraction exiting the second nozzle reactor is re-injected into the second nozzle reactor may be similar to the re-injection of heavy hydrocarbon fraction into the first nozzle reactor as described in greater detail above. For example, the heavy hydrocarbon fraction may be re-injected into the second nozzle reactor via the same material feed passage by which the initial heavy hydrocarbon fraction is injected into the second nozzle reactor or via a separate injection passage provided specifically for re-injection of material that has already been passed through the second nozzle reactor. The heavy hydrocarbon fraction collected from the second nozzle reactor may also be re-injected into the second nozzle reactor together with heavy hydrocarbon fraction collected from the first nozzle reactor, such as by mixing the two heavy hydrocarbon fractions prior to injection into the second nozzle reactor or via simultaneous injection through different injection passages.

As with the re-injection of heavy hydrocarbon fraction into the first nozzle reactor, the re-injection of heavy hydrocarbon into the second nozzle reactor may increase the overall concentration and amount of liquid heavy hydrocarbon fraction entering the second nozzle reactor. In this manner, the overall conversion rate of heavy hydrocarbon fraction into lighter hydrocarbon molecules may be increased.

As with heavy hydrocarbon fraction re-injected into the first nozzle reactor, heavy hydrocarbon fraction re-injected into the second nozzle reactor may undergo pretreatment prior to injection into the second nozzle reactor. Such pre-treatment may include heating or cooling the heavy hydrocarbon fraction and mixing the heavy hydrocarbon fraction with a material that may make the heavy hydrocarbon fraction more injectable.

The steps of collecting heavy hydrocarbon fraction exiting the second nozzle reactor and re-injecting the heavy hydrocarbon fraction into the second nozzle reactor may be repeated one or more times in order to reduce or possibly eliminate the heavy hydrocarbon fraction exiting the second nozzle reactor. In some embodiments, the heavy hydrocarbon fraction exiting the second nozzle reactor may get progressively softer or more liquid-like with each pass through the second nozzle reactor. As described above, applicants believe this to be evidence that the heavy hydrocarbon fraction may eventually be eliminated.

The second nozzle reactor for the recycling of heavy hydrocarbon fraction may be operated at less extreme operating conditions than the first nozzle reactor. For example, the second nozzle reactor may be operated at lower temperatures or a lower steam to oil ratio than the first nozzle reactor. Adjusting the operating conditions of the second nozzle reactor may also maximize the cracking of certain fractions within the solid pitch, such as the resin component of the solid pitch.

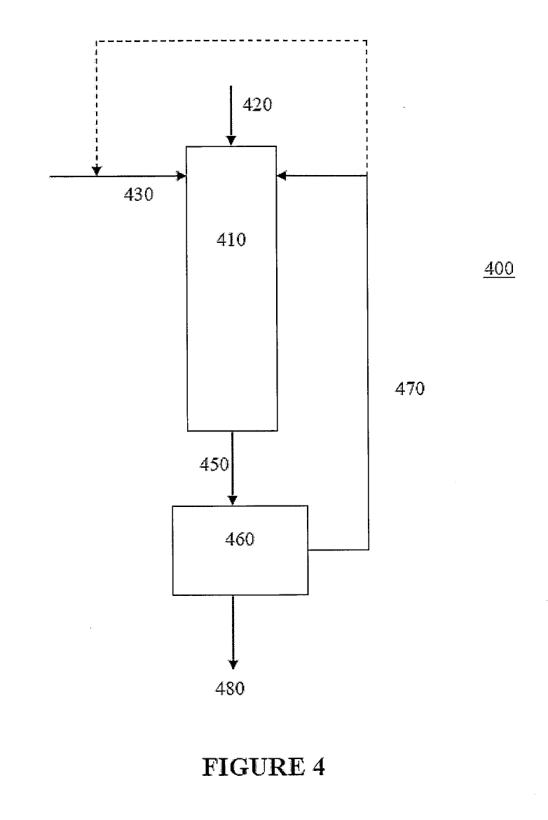

With reference to FIG. 4, a system 400 for carrying out the method described herein may include a first nozzle reactor 410. The first nozzle reactor 410 may have a configuration as shown in FIGS. 2 and 3 and described in greater detail above. A cracking material stream 420 may be injected into the first nozzle reactor 410 in a direction parallel to the axis of the first nozzle reactor 410. In some embodiments, the cracking material stream 420 includes steam. A hydrocarbon material stream 430 may also be injected into the first nozzle reactor 410. The hydrocarbon material stream 430 may be injected into the first nozzle reactor 410 at a direction transverse to the direction the cracking material stream 420 is injected into the first nozzle reactor, although other directions of injection may be used. In some embodiments, the hydrocarbon material stream 430 may include bitumen. The interaction between the cracking material stream 420 and the hydrocarbon material stream 430 inside the first nozzle reactor 410 may result in the cracking of some of the hydrocarbon material stream 430 while some of the hydrocarbon material stream 430 may remain un-cracked. Accordingly, a mixture 450 of cracked and un-cracked hydrocarbon material may exit the first nozzle reactor. The mixture 450 may be transported into a separation unit 460, where the mixture 450 may be separated into a heavy hydrocarbon fraction 470 and a light hydrocarbon product stream 480. The separation unit 460 may be any suitable separation unit. The heavy hydrocarbon fraction 470 may include the heaviest hydrocarbon molecules of the hydrocarbon material stream 430 that remain un-cracked after passing through the first nozzle reactor. The heavy hydrocarbon fraction 470 may then be recycled back into the first nozzle reactor 410. The heavy hydrocarbon fraction 470 may be re-injected into the first nozzle reactor 410 separate from the hydrocarbon material stream 430 or together with the hydrocarbon material stream 430.

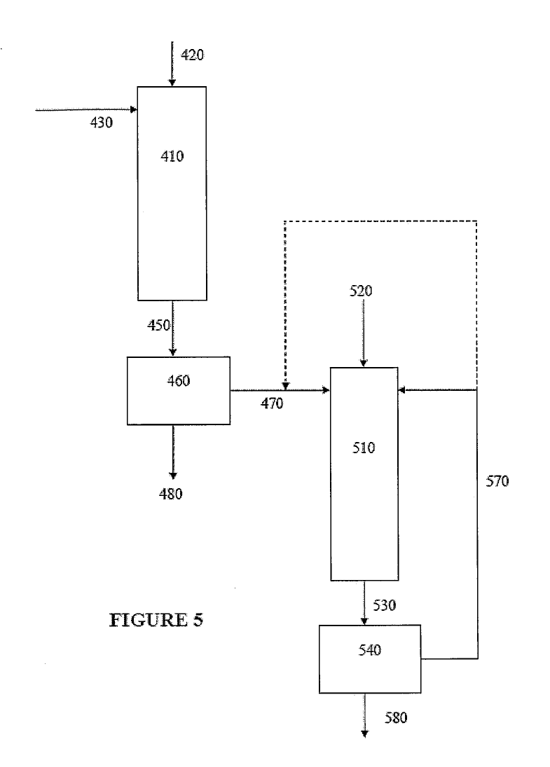

With reference to FIG. 5, an alternate embodiment of the system illustrated in FIG. 4 may include a first nozzle reactor 410 and a second nozzle reactor 510. The heavy hydrocarbon fraction 470 may be injected into the second nozzle reactor 510 rather than re-injecting the heavy hydrocarbon fraction 470 into the first nozzle reactor 410. A cracking material stream 520 may also be injected into the second nozzle reactor 510. As with the configuration of first nozzle reactor 410, the heavy hydrocarbon fraction 470 may be injected into the second nozzle reactor 510 at a direction transverse to the direction the cracking material stream 520 is injected into the second nozzle reactor 510, although other directions of injection may be used. The mixture 530 of cracked and un-cracked hydrocarbon leaving the second nozzle reactor 510 may be transported to a separation unit 540 where the mixture 530 is separated into a heavy hydrocarbon fraction 570 and a light hydrocarbon product stream 580. The heavy hydrocarbon fraction 570 may be recycled back into the second nozzle reactor 510. Re-injection of the heavy hydrocarbon fraction 570 into the second nozzle reactor may be separate from injection of the heavy hydrocarbon fraction 470 into the second nozzle reactor 510 or together with the injection of the heavy hydrocarbon fraction 470 into the second nozzle reactor 510. Additionally, some or all of the heavy hydrocarbon fraction 570 may be recycled back to and injected into the first nozzle reactor 410.

### EXAMPLES

### Example 1

Pure Cold Lake bitumen having a composition shown in Table 5 below was preheated at rate of 3.1 kg per hour in a sand bath heater to a temperature of 405° C. The preheated material was then injected into a nozzle reactor as described above and having the dimensions set forth in Table 4. Superheated steam (at a temperature of 630° C.) was also injected into the nozzle reactor at a steam to oil ratio of 1.7. The temperature at the discharge of the nozzle reactor was 425° C. and a reactor retention time of 1.05 seconds was maintained. The nozzle discharge was distilled at about 470° C. and resulted in a liquid hydrocarbon product (“distillate, once through”) and solid pitch (“residue, once through”). The solid pitch was reheated at a rate of 3.41 kg per hour at a temperature of 405° C. and re-injected into the nozzle reactor with super heated steam at a steam to oil ratio of 1.7. A reactor temperature of 430° C. and a reaction time 1.02 seconds were maintained. The nozzle discharge was distilled at about 470° C., which resulted in a liquid hydrocarbon product (“distillate, first recycle”) and solid pitch (“residue, first recycle”). The once-recycled pitch was reheated at a rate of 3.64 kg per hour at a temperature of 409° C., and the reheated once-recycled pitch and superheated steam were injected into the nozzle reactor at a steam to oil ratio of 1.6. The discharge temperature was 431° C. and a reaction time of 1.04 second was maintained. The nozzle discharge was distilled at about 470° C., which resulted in a liquid hydrocarbon product (“distillate, second recycle”) and solid pitch (“residue, second recycle”). Table 6 below summarizes the composition of the various products in terms of the hydrogen-carbon molar ratio.

TABLE 4

| Nozzle Reactor Component | Size (mm) |
|---|---|
| Injection Passage, Enlarged Volume Injection Section | 3.0 |
| Diameter | |
| Injection Passage, Reduced Volume Mid-Section Diameter | 1.3 |
| Injection Passage, Enlarged Volume Ejection Section | 2.1 |
| Diameter | |
| Injection Passage Length | 12 |
| Interior Reactor Chamber Injection End Diameter | 3.7 |
| Interior Reactor Chamber Ejection End Diameter | 24.6 |
| Interior Reactor Chamber Length | 128 |
| Overall Nozzle Reactor Length | 140 |
| Overall Nozzle Reactor Outside Diameter | 260 |

### Elemental Composition of Cold Lake Bitumen

TABLE 5

| | | | | | MW |
|---|---|---|---|---|---|
| C | H | N | O | S | (g/mol) |
| 84.0% | 10.5% | 0.2% | 1.0% | 4.7% | 490 |

TABLE 6

| | | Nozzle Reactor | | | |
|---|---|---|---|---|---|
| | | C | H | S | H/C |
| Feed | | 82.6% | 10.18% | 4.9% | 1.43 |
| Residue | Once Through | 83.4% | 9.8% | 4.7% | 1.41 |
| | First Recycle | 83.9% | 9.3% | 4.8% | 1.33 |
| | Second Recycle | 83.4% | 9.6% | 6.8% | 1.38 |
| Distillate | Once Through | 83.7% | 11.5% | 4.2% | 1.65 |
| | First Recycle | 83.9% | 11.8% | 3.5% | 1.69 |
| | Second Recycle | 82.4% | 11.3% | 3.6% | 1.64 |

| | | |
|---|---|---|
| Coke | Once Through | No coke or other residue produced |
| | First Recycle | |
| | Second Recycle | |

The possible interaction between the steam and the cracked hydrocarbon can illustrated by monitoring the H/C ratios of the reactor feed and reactor products as the recycled pitch continues to be cracked in subsequent passes through the nozzle reactor. The H/C ratios are set forth in Table 7 below.

TABLE 7

| | Hydrogen - Carbon Molar Ratio | | |
|---|---|---|---|
| | Once | First | Second |
| Parameter | Through | Recycle | Recycle |
| Feed | 1.43 | 1.41 | 1.33 |
| Combined Product | 1.49 | 1.45 | 1.48 |
| % Increase in H/C ratio | 4.2% | 2.8% | 11.3% |

Table 7 illustrates that in all cases the product has a higher H/C ratio and hence a higher hydrogen content than the corresponding feed. Table 7 also illustrates that the hydrogen content could even increases with repetitive recycling.

A small amount of gas was also produced as part of Example 1. The gas produced was generally less than a few percent of the feed. If the gas were to be included in the results, the hydrogen pick up in the products will be further demonstrated, since the gas has a much higher hydrogen content than the other two products (liquid and pitch). However, mass balance negative differentials from a 100 wt % will affect hydrogen and carbon overall mass balances driving them to values below 100 wt % for carbon and about 100 wt % for hydrogen.

### Example 2

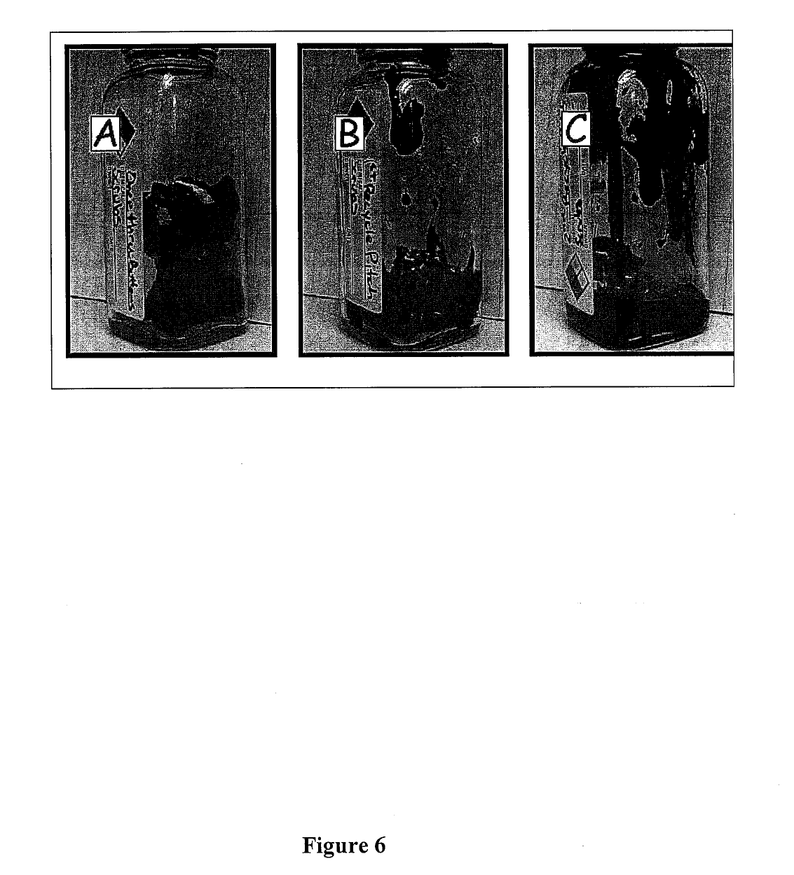

FIGS. 6A-6C depict the consistency of the pitch collected after each pass through the nozzle reactor in Example 1. FIG. 6A shows a pitch product that was obtained when only pure Cold Lake bitumen was passed through the reactor. At room temperature the material was a hard and solid product that was readily broken up into small pieces. The pitch obtained after recycling the pitch shown in FIG. 6A back through the nozzle reactor according to the process described in Example 1 is shown in FIG. 6B. The pitch product was generally much softer at room temperature than the pitch shown in FIG. 6A. The pitch obtained after recycling the pitch shown in FIG. 6B back through the nozzle reactor according to the process described in Example 1 is shown in FIG. 6C. A small amount of pitch was produced. At room temperature, the pitch shown in FIG. 6C had a liquid consistency. Applicants believe that one or more recycle steps of the pitch product may have resulted in a total conversion of the hard pitch into liquid product. Other process, such as coking, that is used to reprocess pitch products tend to produce a pitch that becomes very hard and no longer be liquefied (“petroleum coke”).

### Example 3

The results obtained in Example 1 were compared against a staged distillation of Canadian heavy oil through a coking operation as described in a paper by Murray Gray, et al: “Quality of Distillates from Repeated Recycle of Residue”, Energy & Fuels 2002, 16, 477-484. In the paper the authors present data on the distillation (coking) at 424° C. of Athabasca vacuum residue (+427 deg C. material). Details of the coking test procedures and the flow sheet of the experimental plant can be found in this paper.

The results of the staged coking of Athabasca residue as described in the Gray paper are summarized in Table 8 below.

TABLE 8

| | | Coker | | | |
|---|---|---|---|---|---|
| | | C | H | S | H/C |
| Feed | | 81.4% | 9.6% | 5.8% | 1.42 |
| Residue | Once Through | 83.7% | 9.5% | 5.0% | 1.36 |
| | First Recycle | 84.2% | 8.2% | 5.8% | 1.17 |
| | Second Recycle | 84.5% | 6.6% | 6.6% | 0.94 |
| Distillate | Once Through | 83.7% | 10.6% | 4.9% | 1.52 |
| | First Recycle | 83.3% | 9.9% | 5.6% | 1.43 |
| | Second Recycle | 83.9% | 9.0% | 5.3% | 1.29 |
| Coke | Once Through | 79.4% | 3.1% | 6.6% | 0.47 |
| | First Recycle | 86.9% | 3.5% | 2.6% | 0.48 |
| | Second Recycle | 86.4% | 3.4% | 2.7% | 0.47 |

Comparing Table 8 with Table 6 in Example 2, a number of differences between coking and nozzle processing can be identified. It should be noted that while the feed stocks for each process has a different origin, the chemical composition of the two feed materials is substantially similar.
i. The coker distillation step as carried out at 530° C., whereas the nozzle reaction was controlled at a lower temperature of 430° C.
ii. The results of the once through test for both cases are quite similar if the analyses of both the residue and the distillate are compared, although the nozzle reactor produces a somewhat higher quality distillate.
iii. After the first recycle the coker products are losing hydrogen whereas in the nozzle reactor the presence of steam results in both the residue and the distillate more or less retaining their hydrogen content relative to the once through case.
iv. The distillate products from the nozzle reactor have a higher H/C ratio than the feed, whereas in the case of coking a significant reduction in the H/C ratio becomes apparent after the second recycle.
v. After the second recycle the residue of the coker tests has little excess hydrogen left and a further recycle is likely not possible. The final residue of the nozzle reactor tests has a composition that remains quite similar to the feed implying that further recycle is very much a possibility.
vi. While the coker tests produced a distillate product and a residue for further recycle and a solid residue coke for disposal, the nozzle only produces a liquid product and a recycle residue without any solid disposal material. Furthermore it should be noted that on average a coker converts only up to 65% of its feed into a liquid product. The nozzle reactor on the other hand produces at least 85% liquid product. The remaining 15% can readily be further processed as the residue will be very liquid as shown in FIG. 6C.

### Example 4

Example 1 was carried out several times, and assays were performed on the solid products exiting the nozzle reactor to determine the fraction of the solid product having a boiling point of less than 565° C. The results are summarized below in Table 9.

TABLE 9

| | wt-% <565° C. |
|---|---|
| Process Step | in Residue |
| Distillation | 26.7 |
| Once through | 34.3 |
| First recycle | 42.8 |
| Second recycle | 62.8 |

Table 9 illustrates that an increase in the amount of material being cracked was achieved by including a nozzle reactor recycle stream for solid pitch. Applicants believe that this is contrary to the common understanding that recycling solid pitch material will not lead to an increase in the amount of material being cracked.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. A method comprising:
providing a nozzle reactor, the nozzle reactor comprising:
a reactor body having a reactor body passage with an injection end and an ejection end;
a first material injector having a first material injection passage and being mounted in the nozzle reactor in material injecting communication with the injection end of the reactor body, the first material injection passage having (a) an enlarged volume injection section, an enlarged volume ejection section, and a reduced volume mid-section intermediate the enlarged volume injection section and enlarged volume ejection section, (b) a material injection end, and (c) a material ejection end in injecting communication with the reactor body passage; and
a second material feed port penetrating the reactor body and being adjacent to the material ejection end of the first material injection passage;
injecting a stream of cracking material through the first material injector into the reactor body;
injecting hydrocarbon material through the second material feed port into the reactor body;
collecting a heavy fraction of hydrocarbons exiting the nozzle reactor; and
injecting the heavy fraction of hydrocarbons into the reactor body.

2. The method as recited in claim 1, further comprising repeating the steps of collecting a heavy fraction of hydrocarbons exiting the nozzle reactor and injecting the heavy fraction of hydrocarbons into the reactor body one or more times.

3. The method as recited in claim 1, wherein the cracking material comprises steam.

4. The method as recited in claim 1, wherein the hydrocarbon material comprises bitumen.

5. The method as recited in claim 1, wherein the heavy fraction of hydrocarbons comprises C₅ insoluble asphaltenes, C₇ insoluble asphaltenes, or a mixture thereof.

6. The method as recited in claim 1, wherein the enlarged volume injection section includes a converging central passage section, and the reduced volume mid-section and the enlarged volume ejection section include a diverging central passage section.

7. The method as recited in claim 6, wherein the converging central passage section, the reduced volume mid-section, and the diverging central passage section cooperatively provide a radially inwardly curved passage side wall intermediate the material injection end and material ejection end in the first material injector.

8. The method as recited in claim 1, wherein (a) the reactor body passage has a central rector body axis extending from the injection end to the ejection end of the reactor body passage and (b) the central reactor body axis is coaxial with a first material injection passage axis.

9. The method as recited in claim 1, wherein the enlarged volume injection section, reduced volume mid-section, and enlarged volume ejection section in the first material injection passage cooperatively provide a substantially isentropic passage for a first material feed stock through the first material injection passage.

10. The method as recited in claim 1, wherein the second material feed port is annular.

11. The method as recited in claim 1, wherein the reactor body passage has a varying cross-sectional area and wherein the cross-sectional area of the reactor body passage either maintains constant or increases between the injection end and the ejection end of the reactor body passage.

12. The method as recited in claim 1, wherein the cracking material is accelerated to supersonic speed by the first material injection passage of the first material injector.

13. The method as recited in claim 1, wherein injecting the hydrocarbon material into the reactor body includes injecting the hydrocarbon material into the reactor body annularly around the stream of cracking material.

14. The method as recited in claim 1, wherein the step of injecting the heavy hydrocarbon fraction into the reactor body include injecting the heavy hydrocarbon fraction into the reactor body annularly around the stream of cracking material.

15. A method comprising:
collecting a first nozzle reactor heavy hydrocarbon fraction exiting a first nozzle reactor;
providing a second nozzle reactor, the second nozzle reactor comprising:
a reactor body having a reactor body passage with an injection end and an ejection end;
a first material injector having a first material injection passage and being mounted in the nozzle reactor in material injecting communication with the injection end of the reactor body, the first material injection passage having (a) an enlarged volume injection section, an enlarged volume ejection section, and a reduced volume mid-section intermediate the enlarged volume injection section and enlarged volume ejection section, (b) a material injection end, and (c) a material ejection end in injecting communication with the reactor body passage; and
a second material feed port penetrating the reactor body and being adjacent to the material ejection end of the first material injection passage;
injecting a stream of cracking material through the first material injector into the reactor body;
injecting the first nozzle reactor heavy hydrocarbon fraction through the second material feed port into the reactor body;
collecting a second nozzle reactor heavy hydrocarbon fraction exiting the second nozzle reactor; and
injecting the second nozzle reactor heavy hydrocarbon fraction into the reactor body.

16. The method as recited in claim 15, further comprising repeating the steps of collecting a second nozzle reactor heavy hydrocarbon fraction and injecting the second nozzle reactor heavy hydrocarbon fraction into the reactor body one or more times.

17. The method as recited in claim 1, wherein:
the second material feed port penetrating the reactor body is aligned transverse to a first material injection passage axis extending from the material injection end and material ejection end in the first material injection passage in the first material injector;
the hydrocarbon material is injected through the second material feed port into the reactor body at a direction transverse to the stream of cracking material entering the reactor body from the first material injector; and
the heavy fraction of hydrocarbons is injected into the reactor body at a direction transverse to the stream of cracking material entering the reactor body from the first material injector.

18. The method as recited in claim 15, wherein
the second material feed port penetrating the reactor body is aligned transverse to a first material injection passage axis extending from the material injection end and material ejection end in the first material injection passage in the first material injector;
the first nozzle reactor heavy hydrocarbon fraction is injected through the second material feed port into the reactor body at a direction transverse to the stream of cracking material entering the reactor body from the first material injector; and
the second nozzle reactor heavy hydrocarbon fraction is injected into the reactor body at a direction transverse to the stream of cracking material entering the reactor body from the first material injector.

19. A nozzle reactor comprising:
a reactor body having a reactor body passage with an injection end and an ejection end;
a first material injector having a first material injection passage and being mounted in the nozzle reactor in material injecting communication with the injection end of the reactor body, the first material injection passage having (a) an enlarged volume injection section, an enlarged volume ejection section, and a reduced volume mid-section intermediate the enlarged volume injection section and enlarged volume ejection section, (b) a material injection end, and (c) a material ejection end in injecting communication with the reactor body passage;
a second material feed port penetrating the reactor body and being adjacent to the material ejection end of the first material injection passage; and
an un-cracked material recycle passage having a first end and a second end, wherein the first end is in material receiving communication with the ejection end of the reactor body passage and wherein the second end is in material injecting communication with the reactor body passage at a location adjacent the material ejection end of the first material injection passage.

20. The nozzle reactor as recited in claim 19, wherein the second material feed port penetrating the reactor body is aligned transverse to a first material injection passage axis extending from the material injection end and material ejection end in the first material injection passage in the first material injector.

21. The nozzle reactor as recited in claim 19, wherein the second end of the un-cracked material recycle passage is in material injection communication with the second material feed port.
